(19) United States
(12) Patent Application Publication
(10) Pub. No.: US 2013/0100058 A1
(43) Pub. Date: Apr. 25, 2013

(54) TOUCH DISPLAY PANEL

(71) Applicants: Ming-Chuan Lin, Taichung City (TW); Shih-Chen Wang, Changhua County (TW); Yueh-Chi Fan, Taichung City (TW); Chiung-Chuang Chen, Changhua County (TW)

(72) Inventors: Ming-Chuan Lin, Taichung City (TW); Shih-Chen Wang, Changhua County (TW); Yueh-Chi Fan, Taichung City (TW); Chiung-Chuang Chen, Changhua County (TW)

(21) Appl. No.: 13/651,481

(22) Filed: Oct. 15, 2012

(30) Foreign Application Priority Data
Oct. 19, 2011 (TW) 100137893

(51) Int. Cl. G06F 3/041

(52) U.S. Cl. 345/173

(57) ABSTRACT

A touch display panel includes a transparent substrate, a touch sensing device layer, an isolating layer, and a display device layer. The touch sensing device layer is located on the transparent substrate. The isolating layer has hydrophobic characteristics and covers the touch sensing device layer. The display device layer is located on the isolating layer, and the isolating layer is located between the touch sensing device layer and the display device layer. By this way, a touch sensing function and a display function can be integrated on a transparent substrate, so as to provide a thin touch display panel.

### CROSS-REFERENCE TO RELATED APPLICATION

This application claims the priority benefit of Taiwan application serial no. 100137893, filed on Oct. 19, 2011. The entirety of the above-mentioned patent application is hereby incorporated by reference herein and made a part of this specification.

### BACKGROUND OF THE INVENTION

1. Field of the Invention

The application relates to an electronic device. More particularly, the application relates to a touch display panel.

2. Description of Related Art

In current information era, various information technology (IT) products have replaced conventional input devices (e.g., keyboards or mice) with touch sensing panels. Among the touch sensing panels, a touch display panel capable of performing both a touch sensing function and a display function is one of the most popular products at present.

In general, a touch display panel includes a display panel and a touch sensing panel. To simplify the entire fabrication process, the touch sensing panel is directly adhered to the display panel. Nonetheless, each of the touch sensing panel and the display panel has its own substrate that carries its own components. Even though a touch display panel formed by adhering the touch sensing panel to the display panel having the touch sensing function and the display function, the overall thickness of the touch display panel cannot be effectively reduced, and thus the touch display panel fails to comply with the consumers' demand for compactness and small size of the electronic product. From another perspective, during fabrication, a display device is prone to be affected by moisture dissipated from other films according to the related art, and thereby the display performance of the display device is deteriorated. As such, it is barely possible to directly form the display device and the touch sensing device on the same substrate.

### SUMMARY OF THE INVENTION

The invention is directed to a touch display panel that has a touch sensing function as well as a display function and can be integrated with a cover lens. Thereby, the overall thickness of the touch display panel can be reduced.

In an embodiment of the invention, a touch display panel that includes a transparent substrate, a touch sensing device layer, an isolating layer, and a display device layer is provided. The touch sensing device layer is located on the transparent substrate. The isolating layer covers the touch sensing device layer. The display device layer is located on the isolating layer, and the isolating layer is located between the touch sensing device layer and the display device layer.

According to an embodiment of the invention, the isolating layer has hydrophobic characteristics.

According to an embodiment of the invention, the transparent substrate is a transparent cover lens.

According to an embodiment of the invention, the touch display panel further includes a shielding electrode layer that is located between the isolating layer and the display device layer.

According to an embodiment of the invention, two respective surfaces of the isolating layer are respectively in contact with the touch sensing device layer and the display device layer.

According to an embodiment of the invention, the isolating layer is a thermal-setting polysiloxane polymer.

According to an embodiment of the invention, the display device layer includes an active device array and an organic electroluminescence pixel array. The active device array has a plurality of active devices. The organic electroluminescence pixel array is located on the isolating layer. The organic electroluminescence pixel array has a plurality of organic electroluminescence pixels. Each of the organic electroluminescence pixels is electrically connected to one of the active devices. The organic electroluminescence pixel array may be located between the active device array and the isolating layer. Alternatively, the active device array may be located between the organic electroluminescence pixel array and the isolating layer.

According to an embodiment of the invention, the touch sensing device layer includes a decorative layer and a touch sensing device array. The decorative layer is located on the transparent cover lens. The touch sensing device array is located on the transparent cover lens and includes a plurality of first sensing series, a plurality of second sensing series, and a plurality of transmission lines. Each of the first sensing series extends along a first direction. Each of the second sensing series extends along a second direction. The first direction intersects the second direction, so that the first sensing series intersect the second sensing series. The transmission lines are located at peripheries of the first sensing series and peripheries of the second sensing series. Each of the transmission lines is connected to one of the first sensing series or one of the second sensing series.

According to an embodiment of the invention, the touch display panel has a display region, and the isolating layer entirely covers the touch sensing device layer located in the display region.

Based on the above, in the touch display panel of the invention, the isolating layer with hydrophobic characteristics can effectively isolate the touch sensing device layer from the display device layer, such that the touch sensing device layer and the display device layer are integrated on the same substrate. In an embodiment of the invention, the touch sensing device layer and the display device layer may be directly integrated on the transparent cover lens. Thereby, the display device layer is free from moisture that may be dissipated from the touch sensing device layer, so as to form a thin touch display panel having both the touch sensing function and the display function.

Several exemplary embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1A and FIG. 1B are schematic views briefly illustrating a structure of a touch display panel in the invention.

FIG. 2 is a schematic cross-sectional view illustrating a structure of a touch display panel according to a first embodiment of the invention.

FIG. 3 is a schematic cross-sectional view illustrating a structure of a touch display panel according to a second embodiment of the invention.

FIG. 4 is a schematic cross-sectional view illustrating a structure of a touch display panel according to a third embodiment of the invention.

### DETAILED DESCRIPTION OF DISCLOSED EXEMPLARY EMBODIMENTS

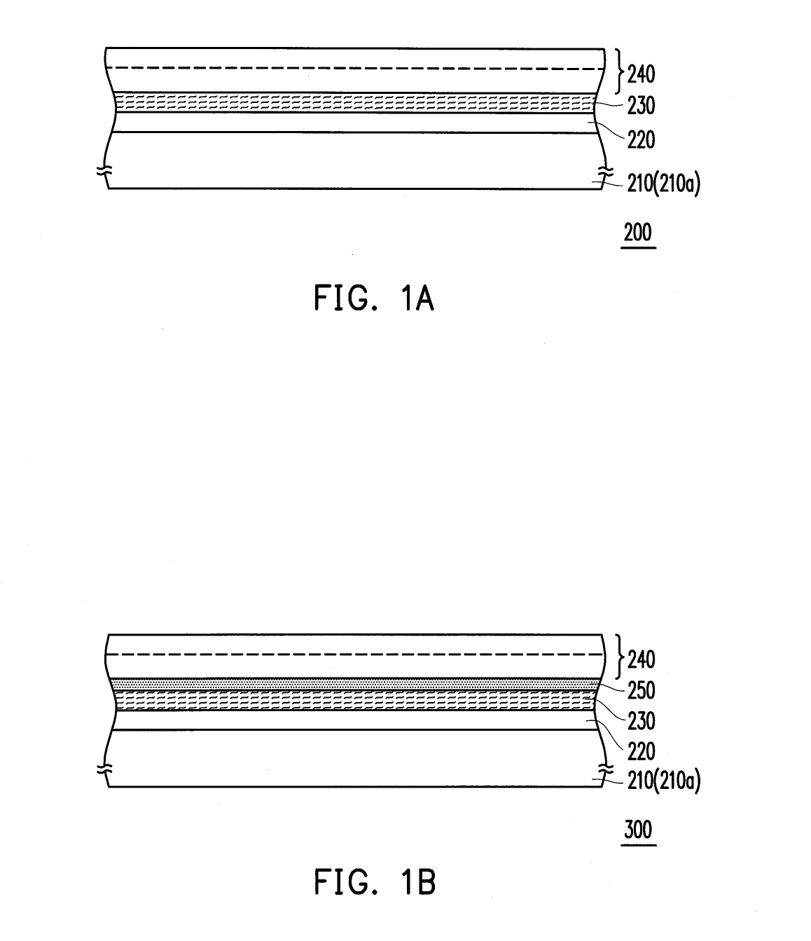

FIG. 1A and FIG. 1B are schematic views briefly illustrating a structure of a touch display panel in the invention. With reference to FIG. 1A, the touch display panel 200 includes a transparent substrate 210, a touch sensing device layer 220, an isolating layer 230, and a display device layer 240. The touch sensing device layer 220 is located on the transparent substrate 210. In this embodiment, the transparent substrate 210 is a transparent cover lens 210a, for instance. The isolating layer 230 has hydrophobic characteristics and covers the touch sensing device layer 220. The display device layer 240 is located on the isolating layer 230, and the isolating layer 230 is located between the touch sensing device layer 220 and the display device layer 240. Since the isolating layer 230 for isolating the lower touch sensing device layer 220 and the upper display device layer 240 has a highly cross-linked structure and hydrophobic characteristics, the lower touch sensing device layer 220 that is already formed does not pose an impact on the display device in the upper display device layer 220 during fabrication of the display device Thereby, the touch sensing device and the display device that together constitute the touch display panel 200 may share the same substrate 210 (e.g., the transparent cover lens 210a). In comparison with the conventional touch display panel in which the touch sensing panel is adhered to the display panel, the touch display panel 200 of this invention is simplified and has reduced thickness because at least the thickness of substrate between the touch sensing device and the display device in the conventional touch display panel does not exist in the touch display panel of the invention.

With reference to FIG. 1B, a shielding electrode layer 250 may be further disposed between the touch sensing device layer 220 and the display device layer 240. As such, signals of the touch sensing device layer 220 do not interfere with signals of the display device layer 240 during operation, which is conducive to improvement of the overall quality of the touch display panel 200. Besides, in FIG. 1B, the location of the shielding electrode layer 250 may be exchanged with the location of the isolating layer 230, which should not be construed as a limitation. Several embodiments are provided hereinafter to clearly describe the touch display panel of the invention. However, the following embodiments do not serve to limit the invention.

### First Embodiment

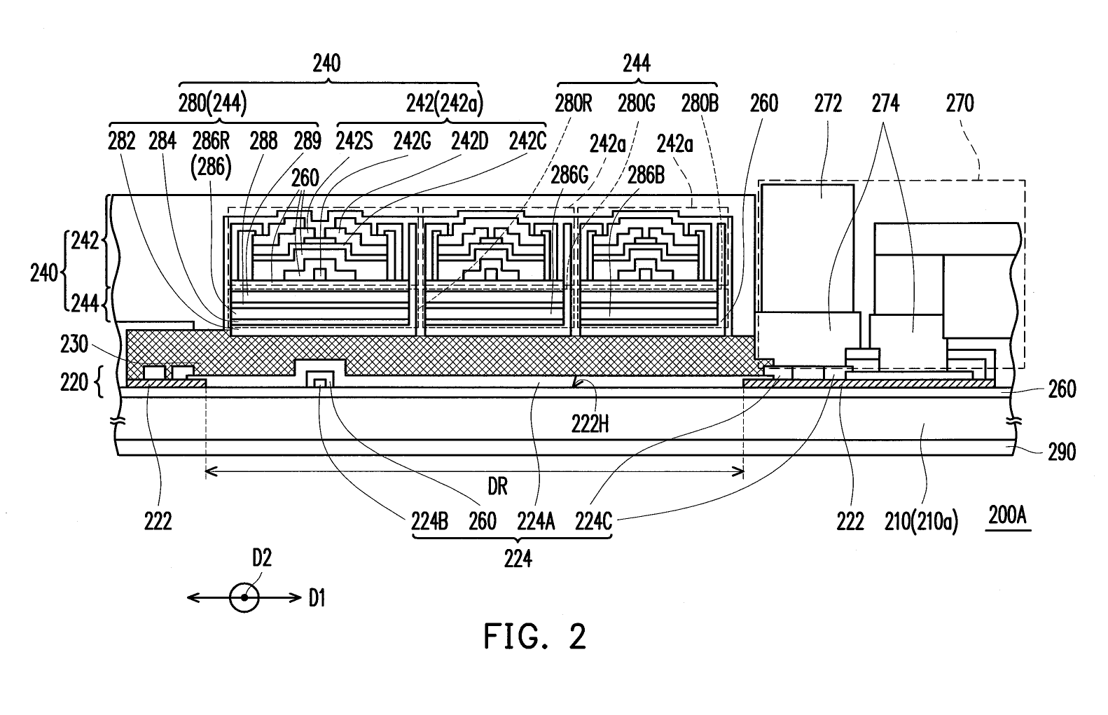

FIG. 2 is a schematic cross-sectional view illustrating a structure of a touch display panel according to a first embodiment of the invention. In particular, FIG. 2 is a schematic view specifically illustrating the structure shown in FIG. 1A. With reference to FIG. 2, the touch display panel 200A includes a transparent substrate 210a, a touch sensing device layer 220, an isolating layer 230, and a display device layer 240. According to this embodiment, the touch display panel 200A and the display device layer 240 share the same transparent cover lens 210a as a carrying substrate that simultaneously carries a stacked structure having the touch sensing device layer 220, the isolating layer 230, and the display device layer 240.

As indicated in FIG. 2, the touch sensing device layer 220 includes a decorative layer 222 and a touch sensing device array 224. The decorative layer 222 and the touch sensing device array 224 are located on the transparent cover lens 210a. In addition, the decorative layer 222 exposes an opening 222H on the transparent cover lens 210a, such that the touch sensing device array 224 forms a touch sensing region at the opening 222H, and that the display device layer 240 forms a pixel display region DR at the opening 222H. In this embodiment, an insulating layer 260 may be formed on the transparent cover lens 210a before forming the touch sensing device layer 220, so as to prevent ions in the transparent cover lens 210a from penetrating the touch sensing device layer 220 in subsequent fabricating processes. This is conducive to improvement of touch sensing performance of the touch sensing device layer 220.

The touch sensing device array 224 includes a plurality of first sensing series 224A, a plurality of second sensing series 224B, and a plurality of transmission lines 224C. Each of the first sensing series 224A extends along a first direction D1, and each of the second sensing series 224B extends along a second direction D2. As indicated in FIG. 2, the second direction D2 is perpendicular to the paper plane, for instance. The first direction D1 intersects the second direction D2, so that the first sensing series 224A intersect the second sensing series 224B. The insulating layer 260 is configured at intersections of the first and second sensing series 224A and 224B, so as to insulate the signals transmitted by the first sensing series 224A from the signals transmitted by the second sensing series 224B. As such, a touch sensing device array may be formed on the entire operating surface of the transparent cover lens 210a.

In addition, the transmission lines 224C are disposed at peripheries of the first sensing series 224A and the peripheries of the second sensing series 224B. Each of the transmission lines 224C is connected to one of the first sensing series 224A or one of the second sensing series 224B, so as to transmit the signals sensed by the first sensing series 224A connected thereto or the second sensing series 224B connected thereto to an external processing circuit 270. For instance, a driving circuit 272 is electrically connected to the transmission lines 224C through an anisotropic conductive film (ACF) 274.

The decorative layer 222 of this embodiment may be located around the transparent cover lens 210a, and edge areas of the entire transparent cover lens 210a are substantially filled with the decorative layer 222, so as to form frame patterns. Thereby, the transmission lines 224C can be shielded and will not be seen by a user when the touch display panel 200A is in use. A material of the decorative layer 222 is ink, diamond like carbon, or photoresist, for instance.

It should be mentioned that the isolating layer 230 having the hydrophobic characteristics is disposed above the touch sensing device layer 220, so as to form a plane above the touch sensing device layer 220. Thereby, each film layer in the display device layer 240 can be continuously formed with ease in subsequent processes. From another perspective, the isolating layer 230 may also effectively isolate the touch sensing device layer 220 from the display device layer 240.

Particularly, the display device layer 240 is, for instance, an active organic light emitting display device that includes an active device array 242 and an organic electroluminescence pixel array 244. According to this embodiment, the organic electroluminescence pixel array 244 is located between the active device array 242 and the isolating layer 230, such that the organic electroluminescence pixel array 244 is directly located on the isolating layer 230 and is not adhered to the touch sensing device layer 220 through another rigid substrate. Besides, the insulating layer 260 may be further disposed between the active device array 242 and the organic electroluminescence pixel array 244, or the insulating layer 260 may be further disposed on the outermost layer of the active device array 242.

As indicated in FIG. 2, the active device array 242 has a plurality of active devices 242a. Each of the active devices 242a is, for instance, a thin film transistor (TFT) with a gate 242G, a channel layer 242C, a source 242S, and a drain 242D. The insulating layer 260 is located between the gate 242G and the channel layer 242C. The organic electroluminescence pixel array 244 has a plurality of organic electroluminescence pixels 280. Each of the organic electroluminescence pixels 280 is electrically connected to one of the active devices 242a. Whether each organic electroluminescence pixel 280 emits light or not may be individually controlled by turning on or turning off one active device 242a, and thereby the display function may be achieved. Light emitted from the organic electroluminescence pixels 280 is toward the transparent cover lens 210a. Besides, to comply with a full-color display requirement, each organic electroluminescence pixel 280 may be constituted by an organic electroluminescence red sub-pixel 280R, an organic electroluminescence green sub-pixel 280G, and an organic electroluminescence blue sub-pixel 280B.

With reference to FIG. 2, each organic electroluminescence pixel 280 on the isolating layer 230 sequentially includes an anode 282, hole-introducing/hole-transporting layer 284, a light emitting layer 286, an electron-transporting layer 288, and a cathode 289. A material of the hole-introducing/hole-transporting layer 284, the light emitting layer 286, and the electron-transporting layer 288 is an organic compound. The light emitting layer 286 may be made of different organic light emitting materials in response to the color light required to be emitted, e.g., the light emitting layer 286 may be a red light emitting layer 286R, a green light emitting layer 286G, or a blue light emitting layer 286B, as shown in FIG. 2. The quality of organic films (e.g., the hole-introducing/hole-transporting layer 284, the light emitting layer 286, and the electron-transporting layer 288) is closely related to the light emitting efficiency and the life span of the organic electroluminescence device. Accordingly, the organic films must be protected from moisture or impurities during evaporation.

It should be mentioned that the isolating layer 230 of this invention has a highly cross-linked structure, and therefore the isolating layer 230 is characterized by heat and weather resistance, favorable electrical insulation, antibiotic resistance, hydrophobic properties, and flame retardancy. The isolating layer 230 may also have other characteristics after modification. During evaporation of the display device layer 240, even though the bottommost touch sensing device layer 220 releases moisture, the moisture can be effectively blocked by the isolating layer 230, so as to preclude the organic films in the display device layer 240 from being affected by moisture during fabrication. Thereby, the display device layer 240 with high quality films may be formed. According to this embodiment, an insulating layer 260 may be configured at the bottommost part of the touch sensing device layer 220, and two respective surfaces of the isolating layer 230 are respectively in contact with the touch sensing device layer 220 and the display device layer 240. Hence, although there is no substrate between the touch sensing device layer 220 and the display device layer 240, the touch sensing device layer 220 can be fully isolated from the display device layer 240 by one single isolating layer 230.

Compared to the conventional touch display panel in which the touch sensing panel is adhered to the display panel, the touch display panel 200A has reduced thickness because at least the thickness of a carrying substrate between the touch sensing device layer 220 and the display device layer 240 does not exist in the touch display panel 200A.

To enhance the isolation effects achieved by the isolating layer 230, the isolating layer 230 may be extensively disposed at almost any place but the peripheral area where the pads are to be bonded by the external circuit 270. For instance, the touch display panel 200A has a display region DR, and the isolating layer 230 entirely covers the touch sensing layer 220 in the display region DR. The isolating layer 230 is entirely formed on an area where the display device layer 240 is to be formed, and the isolating layer 230 serves as a base layer of the display device layer 240. Thereby, films in the display device layer 240 can formed evenly, and the display device layer 240 can be protected effectively from the moisture that may be dissipated from the lower touch sensing device layer 220.

A material of the isolating layer 230 is a thermal-setting polysiloxane polymer, for instance. To be more specific, organic chlorosilane (e.g., MeSiCl₃, Me₂SiCl₂, MePhSiCl₂, PhSiCl₃, and Ph2SiCl₂) is hydrolyzed, condensed, and re-arranged to form active siloxane prepolymer that remains stable at the room temperature. The siloxane prepolymer is heated, condensed, and cross-linked, so as to form rigid or less flexible solid silicon resin for further use. The silicon resin is characterized by favorable electrical insulation, temperature tolerance, and water resistance. In comparison with the normal organic resin, the silicon resin features satisfactory weather resistance. Hence, the silicon resin is an appropriate choice of making the isolating layer that can withstand high temperature, heat, and moisture.

Additionally, the molecular structure of the isolating layer 230 can be properly adjusted based on actual demands for products. For instance, the silicon resin molecule side group in the isolating layer 230 may mainly be the methyl group. If the phenyl group is introduced, thermoelasticity and viscosity of the silicon resin molecule side group can be enhanced, and compatibility of the silicon resin molecule side group with organic polymer and pigment can be improved. If the ethyl group, the propyl group, or the long chain alkyl group is introduced, the affinity of the silicon resin molecule side group to organic polymer can be improved, and the silicon resin molecule side group becomes more hydrophobic. If the vinyl group and the hydrogen group are introduced, the palladium-catalyzed addition reaction and the peroxide cross-linking reaction may occur. If the carbon function group is introduced, the silicon resin molecule side group may react with more organic compounds, so that the isolating layer 230 may be adhered to the substrate to a better extent.

In this embodiment, a polarizing plate may be further adhered to the surface of the transparent cover lens 210a which is opposite to the surface carrying devices in the touch display panel 200A. However, the invention is not limited thereto.

### Second Embodiment

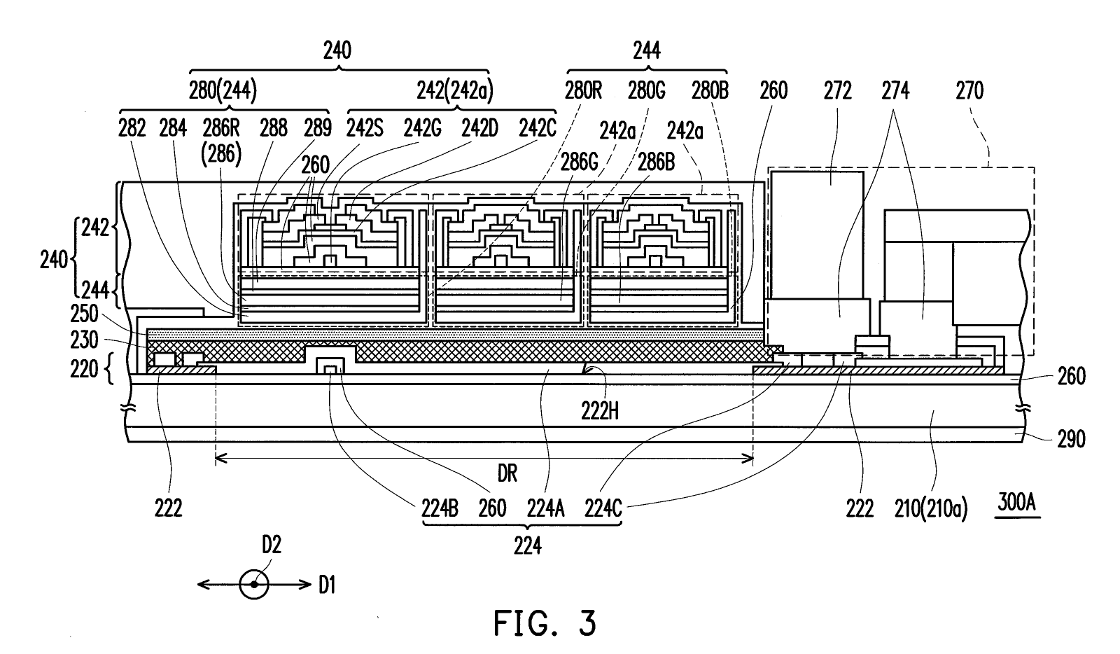

FIG. 3 is a schematic cross-sectional view illustrating a structure of a touch display panel according to a second embodiment of the invention. In particular, FIG. 3 is a schematic view specifically illustrating the structure shown in FIG. 1B. With reference to FIG. 3, the touch display panel 300A is structurally similar to the touch display panel 200A depicted in FIG. 2, while the difference lies in that a shielding electrode layer 250 is further disposed between the isolating layer 230 and the display device layer 240 in the touch display panel 300A of this embodiment. Thereby, it can be further ensured that signals of the touch sensing device layer 220 do not interfere with signals of the display device layer 240, which is conducive to improvement of the overall quality of the touch display panel 300A. The other elements are the same as those described in the first embodiment, and thus relevant descriptions are provided above. Identical reference numerals denote elements identical to those in the first embodiment.

### Third Embodiment

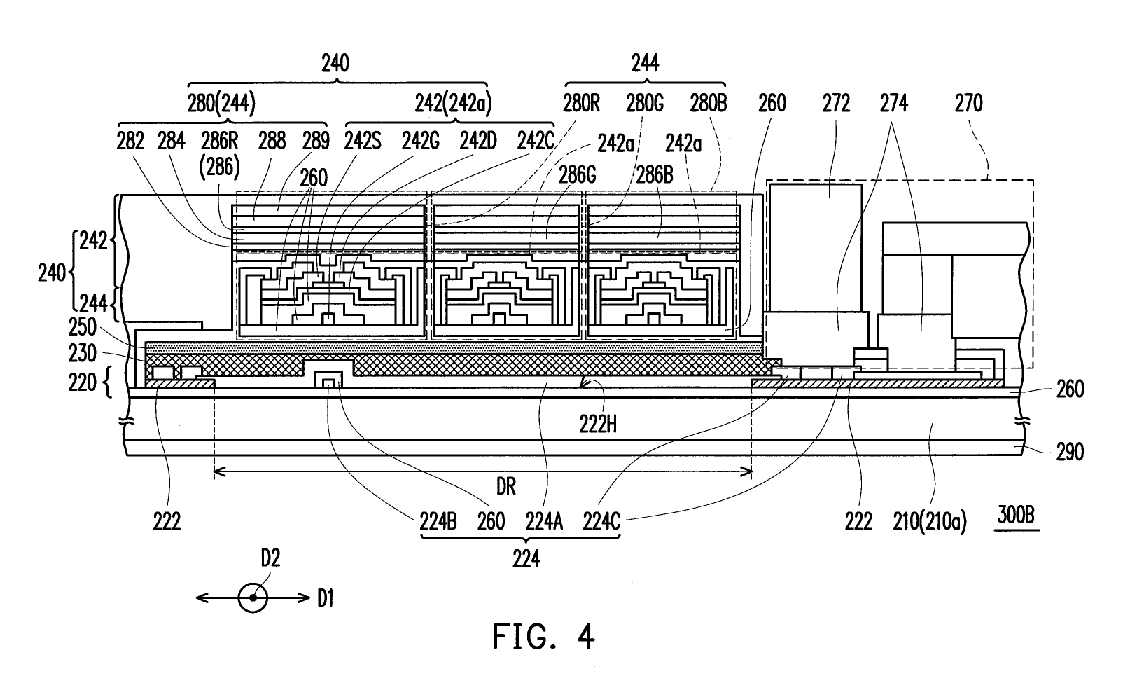

FIG. 4 is a schematic cross-sectional view illustrating a structure of a touch display panel according to a third embodiment of the invention. In particular, FIG. 4 is a schematic view specifically illustrating the structure shown in FIG. 1B. With reference to FIG. 4, the touch display panel 300B is structurally similar to the touch display panel 300A shown in FIG. 3, while the difference lies in that the location of the active device array 242 and the location of the organic electroluminescence pixel array 244 are exchanged in the touch display panel 300B of this embodiment, and the light emitted from the organic electroluminescence pixels 280 is still toward the transparent cover lens 210a. The other elements are the same as those described in the first embodiment, and thus relevant descriptions are provided above. Identical reference numerals denote elements identical to those in the first embodiment.

In light of the foregoing, the touch display panel of the invention has the isolating layer with the highly cross-linked structure, and the isolating layer isolates the touch sensing device layer from the display device layer. Thereby, even though the display device layer is directly formed on the isolating layer above the touch sensing device layer, the display device layer during fabrication can be effectively protected from moisture dissipated from the touch sensing device layer. Thereby, the touch sensing device layer and the display device layer are integrated on the same substrate (e.g. a transparent cover lens). As a result, a super-thin touch display panel with the touch sensing function, the display function, and even the decorative function can be formed.

It will be apparent to those skilled in the art that various modifications and variations can be made to the structure of the invention without departing from the scope or spirit of the disclosure. In view of the foregoing, it is intended that the disclosure cover modifications and variations of this invention provided they fall within the scope of the following claims and their equivalents.

What is claimed is:

1. A touch display panel comprising:
a transparent substrate;
a touch sensing device layer located on the transparent substrate;
an isolating layer covering the touch sensing device layer; and
a display device layer located on the isolating layer, the isolating layer being located between the touch sensing device layer and the display device layer.

2. The touch display panel as recited in claim 1, wherein the isolating layer has hydrophobic characteristics.

3. The touch display panel as recited in claim 1, wherein the transparent substrate is a transparent cover lens.

4. The touch display panel as recited in claim 1, further comprising a shielding electrode layer located between the isolating layer and the display device layer.

5. The touch display panel as recited in claim 1, wherein two respective surfaces of the isolating layer are respectively in contact with the touch sensing device layer and the display device layer.

6. The touch display panel as recited in claim 1, wherein the isolating layer is a thermal-setting polysiloxane polymer.

7. The touch display panel as recited in claim 1, wherein the display device layer comprises:
an active device array located on the isolating layer, the active device array having a plurality of active devices; and
an organic electroluminescence pixel array located on the isolating layer, the organic electroluminescence pixel array having a plurality of organic electroluminescence pixels, each of the organic electroluminescence pixels being electrically connected to one of the active devices.

8. The touch display panel as recited in claim 7, wherein the organic electroluminescence pixel array is located between the active device array and the isolating layer.

9. The touch display panel as recited in claim 7, wherein the active device array is located between organic electroluminescence pixel array and the isolating layer.

10. The touch display panel as recited in claim 3, wherein the touch sensing device layer comprises:
a decorative layer located on the transparent cover lens;
a touch sensing device array located on the transparent cover lens and comprising:
a plurality of first sensing series, each of the first sensing series extending along a first direction;
a plurality of second sensing series, each of the second sensing series extending along a second direction, wherein the first direction intersects the second direction, so that the first sensing series intersect the second sensing series; and
a plurality of transmission lines located at peripheries of the first sensing series and peripheries of the second sensing series, each of the transmission lines being connected to one of the first sensing series or one of the second sensing series.

11. The touch display panel as recited in claim 10, wherein the touch display panel has a display region, and the isolating layer entirely covers the touch sensing device layer located in the display region.
